(19) United States
(12) Patent Application Publication
(10) Pub. No.: US 2006/0250027 A1
(43) Pub. Date: Nov. 9, 2006

(54) Switching circuit, method and control unit for switching a lighting fixture

(76) Inventor: Andries Cornelis Pasma, Nuis (NL)

Correspondence Address: YOUNG & THOMPSON, 745 SOUTH 23RD STREET, 2ND FLOOR, ARLINGTON, VA, 22202, US

(21) Appl. No.: 10/545,607

(22) PCT Filed: Feb. 17, 2004
(86) PCT No.: PCT/NL04/00121

§ 371 Date: Jun. 19, 2006

(30) Foreign Application Priority Data
Feb. 17, 2003 (NL) 1022716

(51) Int. Cl. H01H 47/00

(52) U.S. Cl. 307/140

(57) ABSTRACT

A switching circuit, method and control unit (1) for controlling electric power supply for lighting fixtures. The switching circuit has a control unit (1) with a sensor (11) for detecting intensity of light reaching the sensor, and a control circuit (2) for transmitting at least two different switching signals (21-23) at different times in response to the detected light intensity falling below a predetermined twilight value. The circuit further has switching devices (34-36), with a receiver (31-33) for receiving switching signals coming from the output circuit and for selectively generating a switching command for switching on the power supply in response to receiving a switching signal specifically intended for the relevant switching device; and a switching assembly (37-39) connected to the receiver for switching the electric power supply in response to a switching command coming from the receiver.

The invention relates to a switching circuit for switching a lighting fixture. The invention also relates to a method for switching lighting fixtures, as well as to a control unit for application in a circuit according to the invention.

A switching circuit is known in practice for remote control of different house lighting, with which a plurality of lighting fixtures in a house can be switched on or off manually. The known switching circuit comprises a manually operated remote control provided with keys. In response to the keys being pressed by a user, the remote control generates a switching signal associated with this key. The switching circuit further comprises switching devices intended for distributed placing, with which the power supply for the lighting fixtures can be switched on and off individually. The switching devices are equipped with receivers which each respond to a specific switching signal and selectively generate a switching command in response to this switching signal, whereby the switch of the switching device switches on or off the power supply for the lighting fixture connected thereto. When no-one is present in the house, the lighting fixtures, i.e. the lamps therein, will not be switched on or off, which is an indication to potential burglars that no-one is at home.

It is also known in practice to switch lighting with a time switch which has been manually set by the user, for instance to switch on at 8 p.m. and switch off at 11 p.m. The burning light thus simulates the presence of an occupant and therefore has a preventive effect against burglary.

A drawback of the use of such time switches is that the presence of the occupant is not simulated very realistically, since the lights switched by the switch all go on and off simultaneously at fixed times. It is of course possible to use a plurality of switches, but this is time-consuming and the problem of fixed times is hereby not resolved. It is an object of the invention to provide a simple solution whereby house interior lighting can simulate the presence of an occupant in a more natural manner.

According to the invention this object is achieved by providing a switching circuit for controlling electric power supply of lighting fixtures, comprising a control unit with a sensor for detecting the intensity of light reaching the sensor; a control circuit coupled to said sensor for transmitting at least two different switching signals at different times in response to the detected light intensity falling below a predetermined twilight value; and at least two switching devices, each comprising: a receiver for receiving switching signals coming from the output circuit and for selectively generating a switching command for switching on the power supply in response to receiving a switching signal specifically intended for the relevant switching device; and a switching assembly connected to said receiver for switching the electric power supply in response to a switching command coming from said receiver.

A switching circuit according to claim 1 simulates the presence of a user in a more natural manner, since only from a moment at which darkness begins to fall to a certain extent are different lighting fixtures switched at different times. The presence of a user is hereby simulated more realistically by the circuit than when all the lighting connected by the circuit is switched on or off at a fixed time, since the time required by a user to make his way to the different electrical devices is simulated.

The circuit furthermore does not give itself away by already switching on lighting when it is not yet beginning to get dark, and that it only comes into operation some time after it becomes dark is also prevented, whereby the unlit house would begin to become noticeable in the early evening between surrounding houses where lights are on. The invention can also be embodied in a method as according to claim 11 which forms the operation of the circuit according to the invention. The invention can also be embodied in a control unit as according to claim 12, which is specifically adapted for application as a component of a switching circuit according to the invention. Specific examples of embodiment aspects of the invention are stated in the dependent claims. Further aspects, details, effects of the invention are further elucidated hereinbelow on the basis of examples and the figures shown in the drawings.

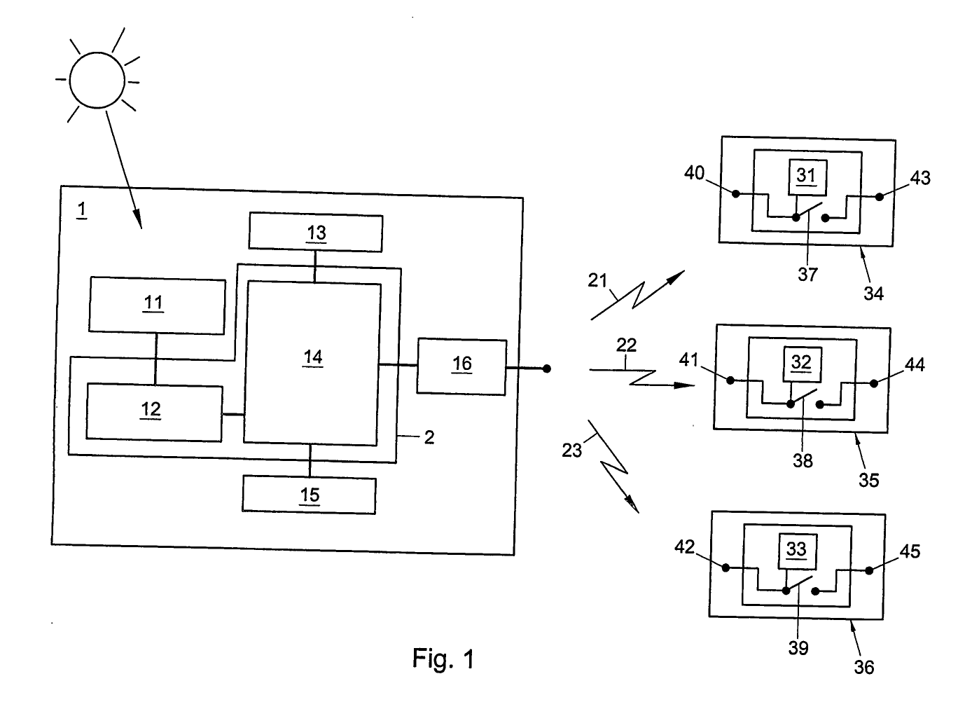

FIG. 1 shows a block diagram of an embodiment of a switching circuit according to the invention.

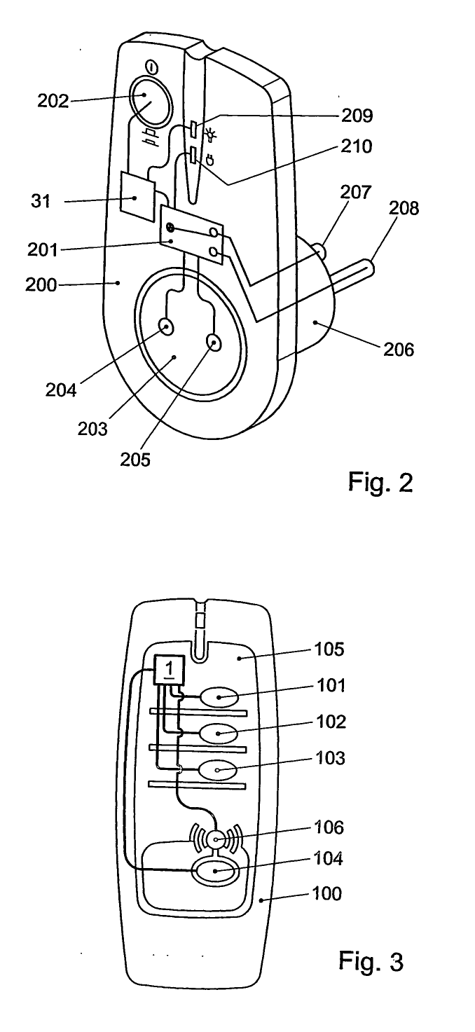

FIG. 2 shows a front view of an embodiment of a receiver for a switching circuit according to the invention.

FIG. 3 shows a front view of an embodiment of a control unit according to the invention.

The embodiment of a switching circuit shown in FIG. I comprises a control unit 1 which can transmit signals 21-23 via a communication connection, in this instance an electromagnetic radio frequency (RF) connection. Receivers 31-33 are adapted to receive signals 21-23 from control unit land at least intended for the relevant receivers.

According to this embodiment the control unit 1 comprises a control circuit 2 with a comparator 12 which generates light intensity-representing signals if the light intensity fulfills a predetermined condition in the space in which a sensor 11 of control unit 1 connected to comparator 12 is situated. Control circuit 2 is adapted to generate switching instructions at different times in response to the signals representing light intensity. These switching instructions are converted by an output circuit into switching signals which are transmitted. According to this embodiment, the output circuit comprises a radio transmitter 16, so that the switching signals can be transmitted as radio frequency signals. Receivers 31-33 form part of switching devices 34-36 placed in distributed manner in an interior of a house. Each of the receivers 31-33 is operatively connected to an associated member of switching assembly or switches 37-38 between contacts 40, 41 respectively 42 and 43, 44 respectively 45, which are adapted for inclusion in a power cable to or from a lighting fixture.

It is noted that switching devices suitable for switching lighting fixtures can of course also be used to switch other domestic electrical appliances such as radios, televisions or electric motors for operating curtains or sunblinds, which can likewise simulate the presence of occupants when switched on and off. Twilight sensor 11 can measure the light intensity of light incident upon twilight sensor 11 and generate an intensity signal to comparator 12 which corresponds with the measured intensity. On the basis of the intensity signal, comparator 12 determines the measured light intensity and compares this intensity to a predetermined, optionally adjustable value. Twilight sensor 11 can for instance be a photoelectric cell which generates to comparator 12 an electric current which is related to the intensity of light incident upon the photoelectric cell.

Comparator 12 can for instance be a differential amplifier where a voltage proportional to the magnitude of the current outputted by the photoelectric cell is supplied to the positive input and a reference voltage, which defines the twilight value and can be optionally adjustable, is supplied to the negative input of the differential amplifier. The positive input of the differential amplifier can for instance be connected to the output of the photoelectric cell and a resistor can connect the positive input to earth, so that the voltage drop over the resistor, and therefore the magnitude of the voltage at the positive input, is proportional to the magnitude of the current from the photoelectric cell.

When the light intensity lies above the twilight value, the voltage drop over the resistor will be greater than the reference voltage due to the current from the photoelectric cell, and the differential amplifier will supply a positive voltage to the amplifier output. If the light intensity is below the twilight value, the voltage drop will be smaller than the reference voltage and the differential amplifier will supply a negative voltage to the amplifier output. In this case the voltage supplied by the amplifier is the signal representing the light intensity, which indicates whether the light intensity is above or below the limit value. A plurality of differential amplifiers and logic circuits for instance can otherwise provide different limit values as it becomes light and dark. In this manner lighting fixtures with a low light-emitting capacity can for instance be switched on as twilight begins and, as it becomes darker, brighter lighting fixtures can be switched on. A further improved simulation of the presence of a user is hereby obtained, since usually the user first requires a little artificial light and switches on more artificial light as it grows darker.

In the shown embodiment control circuit 2 comprises an encoder 14 which is connected communicatively to comparator 12. Encoder 14 is connected to a display 13, a keyboard 15 and a transmitter 16. When the activating signal is received by encoder 14 via the communicative connection to comparator 12, encoder 14 generates coded switching instruction signals. These coded switching instruction signals are supplied to transmitter 16. Transmitter 16 converts the coded signals into switching signals 21-23 for receivers 21-33, in the shown embodiment in the form of radio signals. It is noted that the switching signals can also be transmitted in other manner, for instance via cables, such as the cables of the mains electricity in the house.

In the shown embodiment encoder 14 generates a specific and unique coded signal individually for each of the receivers 31-33 in the switching circuit. The switching signals are transmitted on the same frequency, thus reducing the chance of interference of or by other signal sources, for instance mobile phones, other units of the switching circuit as proposed or otherwise. The switching signals are coded so as to be distinguished from each other by means of different coded signals. Each of receivers 31-33 actuates a switching assembly, in the embodiment a switch 37-39, in response to a specifically coded switching signal associated with the specific receiver 31-33. Receiver 31 can for instance only actuate when a digital code ‘01’ is received, receiver 32 only when a digital code ‘10’ is received and receiver 33 only when a digital code ‘11’ is received.

The receivers 31-33 in the embodiment thus undertake no action as long as the switching signal associated with the specific receiver has not been received. It is however also possible to use switching signals which differ in other respects. Each receiver 31-33 can for instance respond only to a switching signal on a different frequency.

In the embodiment of FIG. 1, each of the receivers 31-33 comprises an input circuit (not shown) for receiving switching signals coming from output circuit 16 and for generating a switching command for switching on the power supply in response to a switching signal specifically intended for the relevant switching circuit. In the embodiment of FIG. 1 the input circuit comprises a decoder (not shown). The decoder can decode coded switching signals and derive therefrom whether the specific switching signal is intended for the relevant switching device.

When, according to the decoder, the switching signal is intended for the switching device in question, the decoder generates a switching command to switch 37-39 which is connected to the decoder in receiver 31-33. In response to the switching command thus originating from receiver 31-33, switch 37-39 then switches the electrical power supply, in the embodiment of FIG. 1 by breaking or opening the connection between electrical contacts 40,43 respectively 41,44 respectively 42,45.

In response to a light intensity representing light intensities below the limit value, encoder 14 can for instance generate the coded signals in a fixed sequence at fixed time intervals, which may or may not be the same as each other. In that case the lamps switched by switches 31-33 are switched on or off in a fixed sequence with a fixed time between switching of successive lamps. There can for instance be a fixed time interval of 5 seconds to 1 minute between the coded signals 21-23 intended for different switching devices. A different time interval is however also possible. Encoder 14 can also generate the coded signals in different sequences with variable time intervals, for instance in a random sequence with a random time lag between switching of successive lamps.

In the embodiment of FIG. 1 the control circuit 1 distinguishes between two signals representing light intensity, which represent light intensity above and below a determined limit value. The control circuit can however also be embodied to provide a plurality of signals representing light intensity which are linked to a plurality of limit values. The control circuit can for instance provide a first signal representing light intensity as a first degree of darkness is reached, and transmit switching instructions whereby some of the lighting fixtures or other connected electrical devices are switched on. When a second twilight value is reached which is lower than the first twilight value, i.e. it has become darker in the space, the control circuit can generate a second signal representing light intensity whereby one or more of the electrical devices not yet switched-on are switched on.

The simulation of the natural behaviour of a user is hereby improved further, since a user will often first switch on only a number of the lamps present in a space in the case of half-light, and will switch on more lamps as it becomes darker.

The control circuit can comprise a twilight detector for providing a first signal if the light intensity falls below a predetermined lower value and for providing a second signal if the light intensity rises above a predetermined lower value; and a timer which determines the time lapse between the first signal and the second signal and stores the recorded time duration in a memory. When a signal representing light intensity is then received again which indicates a fall of the light intensity below the limit value, the control circuit generates a switching instruction and starts a timer. When a period of time has then elapsed which has a preset relation to the value of the recorded time duration stored in the memory, a switching signal is once again generated whereby one or more of switching devices 31-33 opens switch 37-39 to switch off the lighting fixture connected thereto. A further improved simulation of the presence of a user is hereby obtained, since the user will usually go to bed at a determined time after sunset (and thus after the space becomes dark) and will switch of the lights, this time being longer as the time from sunset to sunrise grows longer.

It is noted that a system wherein the control circuit is coupled to the sensor for sensing the increase in the detected light intensity above a predetermined lower value; further comprising: a timer for recording the duration of a time interval between the fall in the detected light intensity below the predetermined twilight value and the increase in the detected light intensity above a predetermined lower value, or vice versa, and wherein the control circuit and the timer are adapted and coupled to determine at least one point in time of one of said switching instructions after the fall of the detected light intensity below the predetermined twilight value and previously to the detected light intensity increasing above a predetermined lower value, subject to the recorded duration of the time interval, can advantageously also be applied for switching a single lighting fixture or a single group of lighting fixtures if the switching circuit comprises only one switching device or only one switch for switching a lighting fixture, as well as when the switching circuit comprises a plurality of switching devices but these can only all be switched on and off simultaneously since provisions for separate switching of (a number of) the switching devices are unavailable. The control unit can optionally also be provided with a clock and setting means for generating a switching instruction at a preset time. The clock can then be set for instance to a point in time at which the user will switch on a television, such as for instance at the start of a news broadcast or a particular television programme.

In the embodiment of FIG. 1 encoder 14 is connected communicatively to display 13. Encoder 14 can provide display 13 with status information which is then shown on the display. Encoder 14 can for instance show on display 13 which lamps are switched on. Encoder 14 is also connected communicatively to a group of keys 15. By means of keys 15 a user can activate or deactivate the control unit, in the shown embodiment by switching the encoder on or off. The keys can also be embodied for manually transmitting signals to the relevant receivers, so that the control unit can also function as remote control for the lamps.

The control unit and the switching devices can be embodied in any way suitable for the specific application. As for instance shown in FIG. 2, the switching device can be incorporated in an adapter plug 200. Adapter plug 200 is particularly suitable for application in an existing situation. Adapter plug 200 comprises a housing with a wall socket 203 with pin holes 204, 205. A plug of an electrical appliance, for instance a lighting fixture, can be placed in wall socket 203. Via a switch 201 the pin holes are electrically connected to plug pins 207, 208 of a plug part 206 of the housing. Plug part 206 can be placed in a wall socket so that electrical power can be supplied to the lamp in the lighting fixture via wall socket 203.

In an open position the switch 201 breaks the electrical connection between plug 206 and wall socket 203. In a closed position the switch 201 opens the electrical connection. A receiver 31 can control the position of switch 201 via a control terminal of switch 201 (see FIG. 1). When receiver 31 receives the switching signal, receiver 31 changes the position of switch 201 so that the electrical contact between the plug and the wall socket is broken or opened, and the lamp can thus be switched on or off.

Receiver 31 can be switched on or off via a key 202 and is also connected to a lamp (or LED) 209 which indicates whether receiver 31 is switched on. Receiver 31 is also connected to a status display, in the embodiment a lamp (or LED) 210 which can light up depending on whether the receiver is switched on or off. Lamp 210 is connected communicatively to switch 201 and can indicate the position of switch 201.

FIG. 3 shows an example of a remote control 100 with a control unit 1 according to the invention. Remote control 100 has a keyboard 105 with keys 101-103 with which a plurality of lamps can be remotely switched on or off manually. Keyboard 105 also has a control key 104 whereby control unit 1 can be switched on or off. The status of the control unit is shown by means of a lamp (or LED) 106 which is on when the control unit is switched on.

The invention is not limited to the above described embodiments. After reading of the foregoing a skilled person will be able to derive variants directly and unambiguously from the shown examples. It will for instance be apparent that a different number of signals or receivers can be used than are shown in the embodiments. It will also be apparent that the signals can be of any type suitable for the specific implementation, such as for instance (ultrasonic) sound signals, electrical signals, electromagnetic signals or otherwise.

It will also be apparent that, in addition to or instead of the twilight sensor, other sensors can be applied, such as for instance fire sensors or intrusion sensors. The sensors can, also or instead, detect a physical parameter other than the light intensity and be for instance pyroelectric sensors, vibration sensors, ultrasonic sensors, radar sensors, mechanical sensors, radio-active sensors, biological sensors or otherwise.

It will also be apparent that components of the circuit with a different function can be implemented physically as a single element. In the embodiment of FIG. 1 for instance, the control device and the output device can be implemented as a single integrated circuit.

It will also be apparent that a power supply device with a switching device in a switching circuit according to the invention can be integrated into a lighting fixture. The word ‘comprising’ does not preclude one or more other elements than those stated from being present.

1. Switching circuit for controlling electric power supply for a lighting fixture, comprising a control unit (1) with a sensor (11) for detecting an intensity of light reaching the sensor; a control circuit (2) coupled to said sensor for transmitting at least two different switching signals (21-23) at different times in response to the detected light intensity falling below a predetermined twilight value; and at least two switching devices (34- 36), each comprising: a receiver (31-33) for receiving switching signals coming from the output circuit and for selectively generating a switching command for switching on the power supply in response to receiving a switching signal specifically intended for the relevant switching device; and a switching assembly (37-39) connected to said receiver for switching the electric power supply in response to a switching command coming from said receiver.

2. Circuit as claimed in claim 1, wherein the control circuit (2) is coupled to said sensor (11) for sensing the increase in the detected light intensity above a predetermined lower value; which circuit further comprises: a timer for recording the duration of a time interval between the fall of the detected light intensity below the predetermined twilight value and the increase in the detected light intensity above the predetermined lower value, or vice versa, and wherein the control circuit (2) and the timer are adapted and coupled to determine at least one point in time of at least one of said switching signals after the fall in the detected light intensity below the predetermined twilight value and before the increase in the detected light intensity above a predetermined lower value, subject to said recorded duration of said time interval.

3. Circuit as claimed in claim 1, wherein the control circuit (2) is adapted to generate a first and at least one subsequent switching signal as switch-on signals for switching on at least two different power supplies.

4. Circuit as claimed in claim 1, wherein the control circuit (2) and the receivers (31-33) are adapted for wireless signal transfer.

5. Circuit as claimed in claim 4, wherein the receivers (31-33) of the different switching devices (34-36) are adapted to receive switching signals (21-23) on the same frequency band.

6. Circuit as claimed in claim 1, wherein the control circuit (2) and the receivers (31-33) are adapted to generate and receive switching signals (21-23) which represent different digital switching codes.

7. Circuit as claimed in claim 1, comprising a housing in which the control circuit (2) is situated, which housing is also provided with manually operated control members (101-105) for manually operating the control circuit (2).

8. Circuit as claimed in claim 1, wherein at least one of the receivers (31-33) is provided with contact pins (207-208) for placing in a wall socket and connected to the switching assembly (37-39).

9. Circuit as claimed in claim 1, wherein the control circuit (2) is adapted to determine the different times at which the different switching signals (21-23) are transmitted.

10. Circuit as claimed in claim 9, wherein the control circuit (2) can be adjusted to set different time durations between successive switching signals (21-23).

11. Method for switching at least two lighting fixtures, comprising of:
detecting light intensity of ambient light; transmitting at least two different switching signals at different times in response to a fall in the detected light intensity below a predetermined twilight value; receiving the switching signals; and selectively switching at least two different lighting fixtures in response to the different switching signals.

12. Control unit (1) for a switching circuit as claimed in claim 1, comprising: a sensor (11) for detecting light intensity which reaches the sensor and a control circuit (2) coupled to said sensor for transmitting at least two different switching signals (21-23) at different times in response to fall of the detected light intensity below a predetermined twilight value.

13. Circuit as claimed in claim 2, wherein the control circuit (2) is adapted to generate a first and at least one subsequent switching signal as switch-on signals for switching on at least two different power supplies.
